(19) United States
(12) Patent Application Publication
(10) Pub. No.: US 2011/0170820 A1
(43) Pub. Date: Jul. 14, 2011

(54) EO POLYMER-BASED DUAL SLOT WAVEGUIDE MODULATORS

(75) Inventors: DENNIS PRATHER, Newark, DE (US); Shouyuan Shi, Newark, DE (US)

(73) Assignee: University of Delaware, Newark, DE (US)

(21) Appl. No.: 12/939,408

(22) Filed: Nov. 4, 2010

Related U.S. Application Data
(60) Provisional application No. 61/257,990, filed on Nov. 4, 2009.

(51) Int. Cl. G02F 1/035; G02F 1/00

(52) U.S. Cl. 385/2; 359/321

(57) ABSTRACT

Electro-optic modulators are disclosed. An electro-optic modulator comprises an electro-optic polymer layer, semiconductor layers, ferroelectric material layers, and electrodes. The semiconductor layers are positioned on each surface of the electro-optic polymer layer. The refractive index of the semiconductor layers in the optical and RF domains is higher than the refractive index of the electro-optic polymer layer in the optical and RF domains. The ferroelectric material layers are positioned on each semiconductor layer opposite the electro-optic polymer layer. The refractive index of the ferroelectric material layers in the RF domain is higher than the refractive indices of both the electro-optic polymer layer and the semiconductor layers in the RF domain. The refractive index of the ferroelectric material layers in the optical domain is lower than the refractive index of the semiconductor layer in the optical domain. The electrodes are positioned on each ferroelectric material layer opposite the semiconductor layer.

### CROSS REFERENCE TO RELATED APPLICATIONS

This application claims priority to U.S. Provisional Patent Application No. 61/257,990, the contents of which are incorporated herein by reference in their entirety.

### STATEMENT REGARDING FEDERALLY SPONSORED RESEARCH

This invention was made with support under Grant No. FA9550-10-0039 from the Air Force Office of Scientific Research. The government may have rights in this invention.

### FIELD OF THE INVENTION

The present invention relates generally to modulator technology, and more particularly to high-speed electro-optic modulators.

### BACKGROUND OF THE INVENTION

Electro-optic (EO) modulators are optical devices in which material that exhibits the electro-optic effect is used to modulate an electrical signal (RF signal) on to a beam of light. In recent years, EO modulators have gained focus due to their wide variety of uses in broadband communication, RF-photonic links, millimeter wave imaging and phased-array radars. In order to achieve an ultra-wide band operation, i.e., up to millimeter wave and even terahertz regime, traveling wave EO modulators are typically used, in which both optical and RF modes co-propagate in the same direction and at the same speed in the waveguide. Tight mode overlap and confinement between optical and RF modes leads to a strong nonlinear interaction, thereby resulting in a high modulation efficiency. Important characteristics of EO modulators include operational speed, modulation efficiency, drive voltage, and/or electro-optic response. EO modulators demonstrating improvements in these characteristics are desired.

### SUMMARY OF THE INVENTION

Aspects of the present invention are directed to electro-optic modulators.

In accordance with an aspect of the present invention, an electro-optic modulator is disclosed. The electro-optic modulator comprises an electro-optic polymer layer, semiconductor layers, ferroelectric material layers, and electrodes. The electro-optic polymer layer has a first surface and a second surface opposite the first surface. The electro-optic polymer layer has a refractive index in the optical domain and a refractive index in the RF domain. The semiconductor layers are positioned on each of the first and second surfaces of the electro-optic polymer layer. Each semiconductor layer has a refractive index in the optical domain and a refractive index in the RF domain. The refractive index of the semiconductor layers in the optical domain is higher than the refractive index of the electro-optic polymer layer in the optical domain. The refractive index of the semiconductor layers in the RF domain is higher than the refractive index of the electro-optic polymer layer in the RF domain. The ferroelectric material layers are positioned on a surface of each semiconductor layer opposite the electro-optic polymer layer. Each ferroelectric material layer has a refractive index in the optical domain and a refractive index in the RF domain. The refractive index of the ferroelectric material layers in the RF domain is higher than the refractive indices of both the electro-optic polymer layer and the semiconductor layers in the RF domain. The refractive index of the ferroelectric material layers in the optical domain is lower than the refractive index of the semiconductor layers in the optical domain. The electrodes are positioned on a surface of each ferroelectric material layer opposite the semiconductor layer.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a cross-sectional view of an exemplary electro-optic modulator in accordance with aspects of the present invention;

FIG. 2 is a perspective view of the electro-optic modulator of FIG. 1;

FIGS. 3A-3C are graphs of the broadband frequency response of the modulator of FIG. 1 for effective indices and RF loss, RF impedance, and electro-optic response, respectively;

FIG. 4 is a cross-sectional view of another exemplary electro-optic modulator in accordance with aspects of the present invention;

FIG. 5 is a perspective view of the electro-optic modulator of FIG. 4; and

FIGS. 6A-6C are graphs of the broadband frequency response of the modulator of FIG. 4 for effective indices and RF loss, RF impedance, and electro-optic response, respectively.

### DETAILED DESCRIPTION OF THE INVENTION

Aspects of the invention will now be described with reference to exemplary embodiments. Aspects of the invention are described herein in exemplary modulators that employ electro-optic (EO) polymers. As used herein, the term “electro-optic polymer” is meant to encompass all suitable materials that exhibit an electro-optic effect. The disclosed modulators have a variety of applications including, but not limited to, sensing and detection, communication, RF photonic links, radar application, phased array antenna, millimeter imaging, automobile collision detection. Other suitable applications will be known to one of ordinary skill in the art from the description herein.

Suitable EO polymers for use with the present invention desirably have relatively high EO coefficients, e.g., r₃₃=176 pm/V. Further, suitable EO polymers for use with the present invention desirably also have relatively low refractive indices, e.g., 1.6. Exemplary EO polymers suitable for use with the present invention include, for example, PMMA-DR1 and/or other organic chromophores. Other suitable EO polymers will be known to one of ordinary skill in the art from the description herein.

The properties of the EO polymer materials and ferroelectric materials enable the fabrication of modulators having strong optical and RF mode confinement. Further, the EO polymers in conjunction with the unique device design described herein enable strong overlapping between the optical and RF modes, thereby leading to a significant enhancement of EO modulation and sensitivity. Finally, the exemplary modulators described herein may include a relatively large separation between electrodes, thereby minimizing RF loss and enabling high speed operation.

Applications of the above-described EO polymers are utilized in aspects of the present invention. One aspect generally includes horizontally-oriented dual slot waveguide EO modulators having a first slot confining an optical carrier signal and a second slot overlapping the first slot confining an RF electrical signal. Another aspect generally includes vertically-oriented dual slot waveguide EO modulators. These and other aspects will be described below with reference to the accompanying drawings.

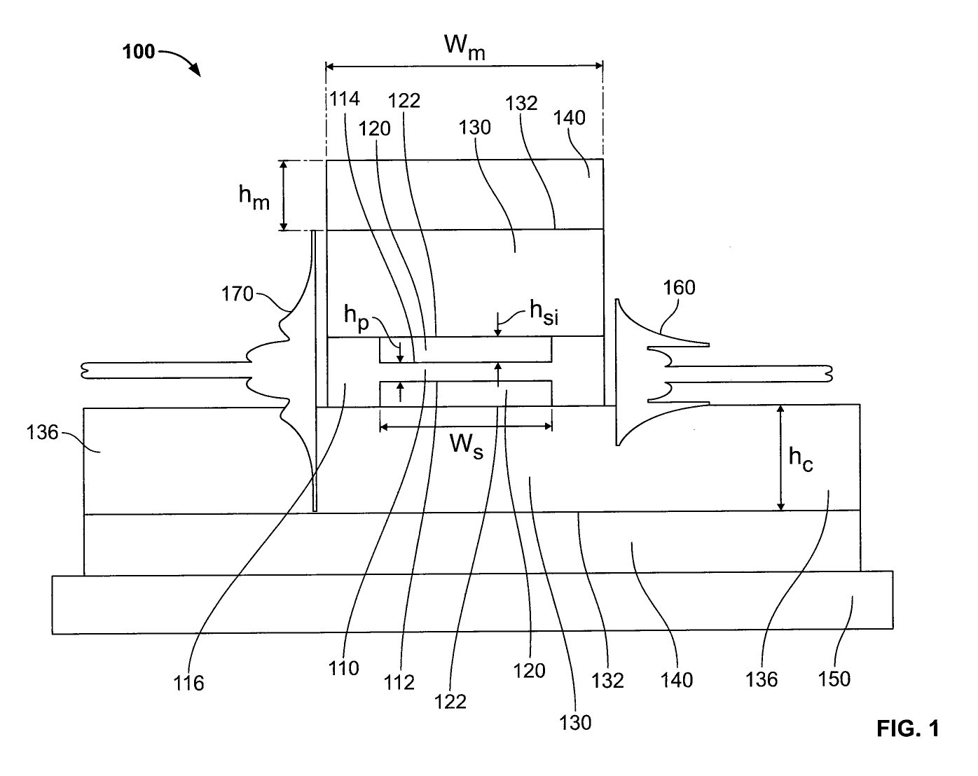

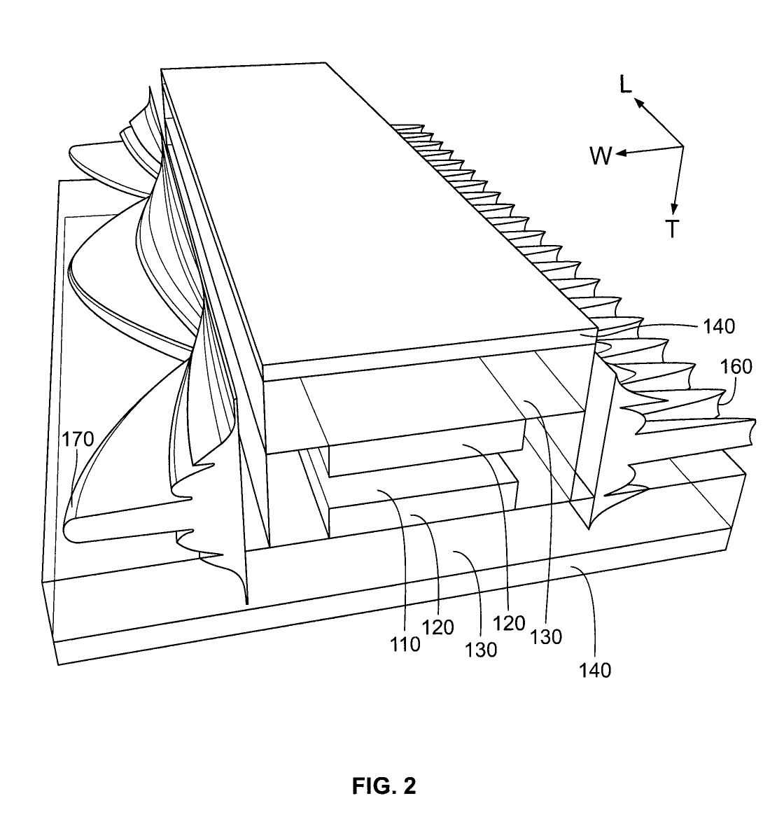

FIGS. 1 and 2 illustrate an exemplary EO modulator 100 in accordance with aspects of the present invention. EO modulator 100 is a horizontal dual slot waveguide modulator. EO modulator 100 is operable to modulate a radio-frequency (RF) signal onto a beam of light. In general, EO modulator 100 includes an EO polymer layer 110, semiconductor layers 120, ferroelectric material layers 130, and electrodes 140. Additional details of EO modulator 100 are described below.

EO polymer layer 110 provides slots for confining optical and RF modes in EO modulator 100. As shown in FIG. 1, EO polymer layer 110 has a first surface 112 and a second surface 114 opposite the first surface. EO polymer layer 110 has a relatively low refractive index. For example, EO polymer layer 110 may have a refractive index of approximately 1.6 in the optical domain and approximately 1.6 in the RF domain. EO polymer layer 110 further has a relatively high EO coefficient. For example, EO polymer layer 110 may have a EO coefficient of approximately r₃₃=10˜300 pm/V. In an exemplary embodiment, EO polymer layer 110 comprises a layer of organic chromophore such as, for example, PMMA-DR1, SEO-100, and/or SEO-200. Other suitable materials for use in forming EO polymer layer 110 will be known to one of ordinary skill in the art from the description herein.

Semiconductor layers 120 are positioned on each side of EO polymer layer 110. As shown in FIG. 1, one semiconductor layer 120 is positioned on surface 112 of EO polymer layer 110, and another semiconductor layer 120 is positioned on surface 114 of EO polymer layer 110. Each semiconductor layer 120 has a surface 122 opposite the EO polymer layer 110. Semiconductor layers 120 have a higher refractive index in the optical domain than EO polymer layer 110. For example, semiconductor layers 120 may have a refractive index of approximately 3.47 in the optical domain and approximately 3.4 in the RF domain. This may be desirable in order to promote confinement of the optical wave in EO polymer layer 110. In an exemplary embodiment, semiconductor layers 120 may each comprise one or more layers of silicon. Other suitable materials for use in forming semiconductor layers 120 will be known to one of ordinary skill in the art from the description herein.

Semiconductor layers 120 may desirably be thicker than the portion of EO polymer layer 110 between the semiconductor layers. For example, EO polymer layer 110 may have a thickness of approximately 150 nm, and each semiconductor layer 120 may have a thickness of approximately 200 nm. The thickness of EO polymer layer 110 and semiconductor layer 120 are optimized to achieve a single mode operation in the optical domain. The thicknesses are selected based on the optical operational wavelength. For example, the thicknesses of layers 110 and 120 may be designed for the telecommunications band with a wavelength near 1.55 micrometers. As shown in FIG. 1, a portion 116 of EO polymer layer 110 may extend beyond one or more edges of semiconductor layers 120. This portion 116 of EO polymer layer 110 may have a thickness greater than the portion of EO polymer layer 110 between semiconductor layers 120. For example, as shown in FIG. 1, portion 116 may be approximately as thick as the combined thickness of EO polymer layer 110 and semiconductor layers 120.

Ferroelectric material layers 130 are positioned on the side of each semiconductor layer 120 opposite EO polymer layer 110. As shown in FIG. 1, one ferroelectric material layer 130 is positioned on surface 122 of one semiconductor layer 120, and another ferroelectric material layer 130 is positioned on surface 122 of another semiconductor layer 120. Each ferroelectric material layer 130 has a surface 132 opposite the respective semiconductor layer 120. Ferroelectric material layers 130 have a lower refractive index in the optical domain than semiconductor layers 120, and a higher refractive index in the RF domain than semiconductor layers 120. For example, ferroelectric material layers 130 are anisotropic materials, and may have a refractive index of approximately 2.18-2.2 in the optical domain and approximately 5.3-6.3 in the RF domain, dependent on the crystal direction. This may be desirable, for example, in order to promote confinement of the RF wave in EO polymer layer 110. In an exemplary embodiment, ferroelectric material layers 130 comprise at least one of LiNBO₃ and TIO₂. Other suitable ferroelectric materials for use in ferroelectric material layers 130 will be known to one of ordinary skill in the art from the description herein. While ferroelectric material layers 130 are described herein as comprising the same material, they are not so limited. It will be understood to one of ordinary skill in the art from the description herein that the different materials may be used for the ferroelectric material layers on different sides of EO polymer layer 110.

Ferroelectric material layers 130 may desirably be thicker than the combined thickness of EO polymer layer 110 and semiconductor layers 120. For example, each ferroelectric material layer 130 may have a thickness of between 8 and 20 micrometers. As shown in FIG. 1, a portion 136 of ferroelectric material layers 130 may extend beyond the edges of EO polymer layer 110 and semiconductor layers 120. The arrangement of ferroelectric layer 130 is necessary to attain an optimal confinement of both optical and RF modes into the EO polymer slot 110. The choice of the thicknesses of semiconductor 120 and EO polymer 110 and ferroelectric 130 layers can be varied, and the basic design guidance is to maximize the optical and RF mode confinement factor in the EO materials 110 as well as reduce the both RF and optical loss.

Electrodes 140 are positioned on the side of each ferroelectric material layer 130 opposite respective semiconductor layers 120. Electrodes 140 are coupled to apply an electric field across EO polymer layer 110, semiconductor layers 120, and ferroelectric material layers 130. For example, one electrode 140 may be a signal electrode, and the other electrode 140 may be a ground electrode. The signal electrode 140 may apply an electric field across EO modulator 100 based on a signal received from a signal source (not shown). For example, signal electrode 140 may receive an RF signal from a receiving antenna, and apply the RF signal as an electric field across EO modulator 100. In an exemplary embodiment, electrodes 140 are formed from conductive material such as gold. Other suitable conductive materials will be known to one of ordinary skill in the art from the description herein.

As shown in FIG. 2, for example, each layer of EO modulator 100 has a length much greater than its width. EO modulator 100 may be approximately 1-2 cm long (the length direction indicated by arrow L in FIG. 2) and approximately 10-20 μm wide (the width direction indicated by arrow W in FIG. 2). The length of EO modulator 100 may desirably be selected based on the RF frequencies to be confined within EO polymer layer 110.

EO modulator 100 is desirably mounted to a substrate 150. Substrate 150 may be a conventional complementary metal-oxide-semiconductor (CMOS) substrate. As shown in FIG. 1, the thickness direction of the EO polymer layer 110 (indicated by arrow T in FIG. 2) is substantially orthogonal to the plane of substrate 150 (i.e., EO modulator 100 has horizontally-oriented slots for confining the optical and RF modes). While only one EO modulator 100 is shown in FIG. 1, it will be understood that multiple EO modulators 100 may be arrayed in parallel on the same substrate 150. A single modulator may be used to produce a phase modulation. Where multiple EO modulators 100 are used, two modulators may be used together as a push-pull EO modulator configuration to form an intensity modulator, as would be understood to one of ordinary skill in the art from the description herein.

EO modulator 100 may be fabricated through conventional lithography methods. For example, a first electrode 140 may be deposited on a substrate 150 by conventional vapor deposition techniques. A first ferroelectric layer 130 may then be deposited on the first electrode 140, followed by a first semiconductor layer 120, followed by EO polymer layer 110. Following the deposition of EO polymer layer, a second semiconductor layer 120 may be deposited, followed by a second ferroelectric material layer 130, followed by a second electrode 140. Where a portion 136 of the second ferroelectric material layer 130 extends beyond the edges of the second semiconductor layer 120, a mask may be used to prevent contact between the two ferroelectric material layers 130. Additionally or alternatively, semiconductor nanomembrane technology may be suitable for integrating the top and bottom halves of EO modulator 100. Suitable fabrication methods will be understood by one of ordinary skill in the art from the description herein.

The operation of EO modulator 100 will now be described. Signal electrode 140 first receives an electrical signal to be modulated by EO modulator 100. The signal may include a carrier signal in the optical domain and a modulation drive signal in the RF domain. Electrode 140 applies the signal (in the form of an electric field) across EO polymer layer 110, semiconductor layers 120, and ferroelectric material layers 130 in the thickness direction. The optical portion of the signal is confined within EO polymer layer 110 between semiconductor layers 120 (as shown by diagram 160 in FIG. 1). Diagram 160 shows an exemplary confinement profile of the optical mode within EO polymer layer 110. This is due to the lower optical refractive index of EO polymer layer 110 and ferroelectric materials layer 130 relative to semiconductor layers 120. The degree of optical confinement in the EO polymer layer 110 may be defined as the ratio of the propagation power inside the slot to the total power of the guiding mode:

$$Γ = \frac{{\int }_{Slot} Re ( E \times H ) d s}{{\int }_{Waveguide} Re ( E \times H ) d s}$$

where Γ is the optical confinement factor, E is the strength of the electric field, H is the strength of the associated magnetic field, RE is the real portion of their product, and S is the cross-sectional area of the layer. EO modulator 100 may achieve an optical confinement factor Γ in the EO polymer layer 110 of at least approximately 45%.

Additionally, during operation, EO modulator 100 will confine the RF portion of the signal within EO polymer layer 110 (as shown by diagram 170 in FIG. 1). Diagram 170 shows an exemplary confinement profile of the RF mode within EO polymer layer 110. This is due to the lower RF refractive index of EO polymer layer 110 and semiconductor layers 120 relative to ferroelectric material layers 130. The degree of RF confinement in EO polymer layer 110 can be determined similarly to the optical confinement factor. In an exemplary embodiment, when a voltage of 1 volt is applied between signal and ground electrodes 140, EO modulator 100 may achieve an RF confinement of over 3.6×10⁶ V/m. Strong electric distribution within the EO polymer layer 110 is desirable because the induced index change of the EO polymer material is proportional to the strength of the locally applied electric field. Confinement of both optical and RF modes may desirably enable high bandwidth operation of EO modulator 100.

The above-described electric field confinement within EO polymer layer 110 induces a significant change in the refractive index of EO polymer layer 110, therefore resulting in a large EO modulation. Additionally, ferroelectric material layers 130 allow for a relatively large separation between electrodes 140, e.g., 12 μm, without significantly decreasing the electric field confinement in EO polymer layer 110. As a result, the RF mode may experience reduced conduction loss.

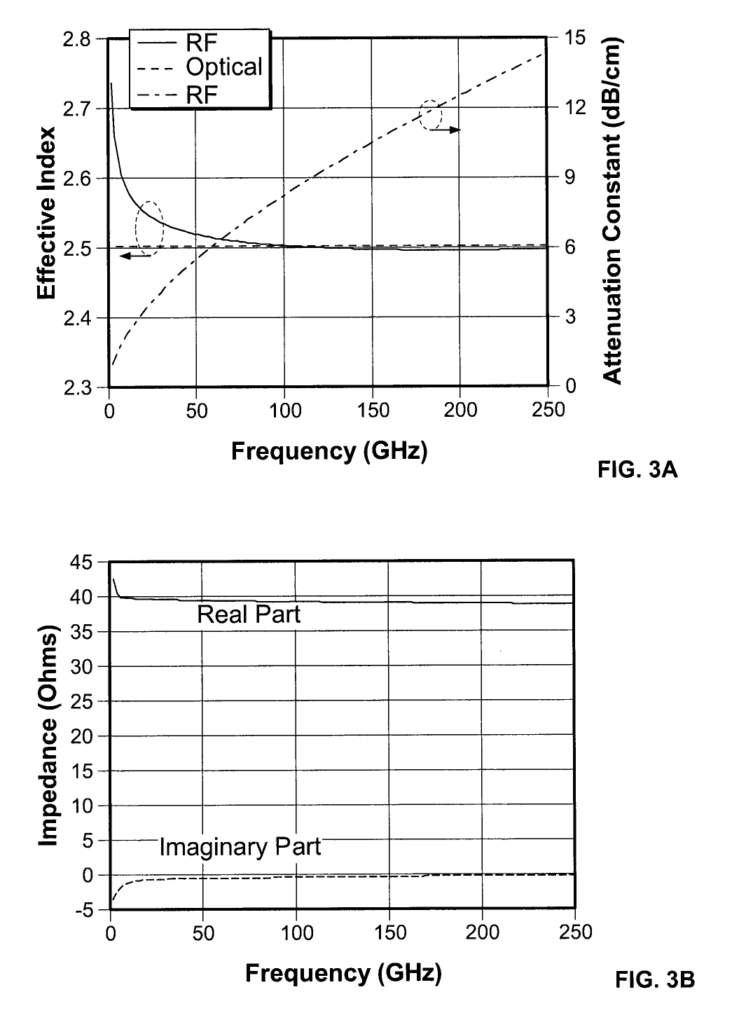

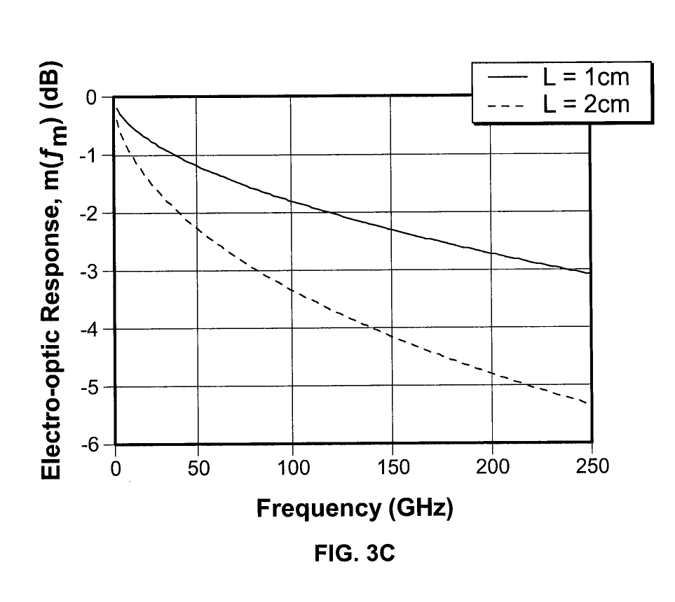

This may be particularly important for operation of EO modulator 100 at high frequencies. As the RF frequency increases, the RF propagation loss increases. Therefore, along the waveguide, the decreased electric field will reduce the interaction with the optical mode through the nonlinear EO material of EO polymer layer 110. As a result, the electro-optic response due to the RF loss will reduce accordingly. FIGS. 3A-3C are graphs of the broadband frequency response of EO modulator 100 for optical and RF effective indices and RF loss (FIG. 3A), RF impedance (FIG. 3B) and electro-optic response (FIG. 3C). The graphs show that EO modulator 100 is capable of operating at frequencies above approximately 250 GHz, which covers nearly the entire RF spectrum, i.e., from 0-300 GHz.

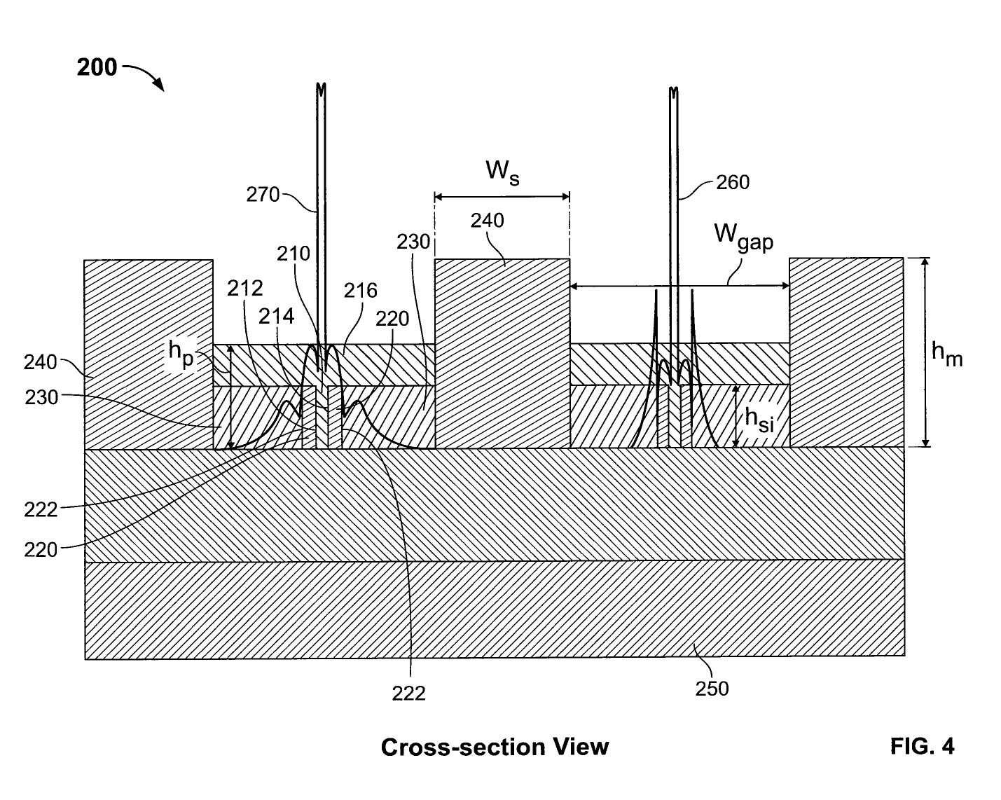

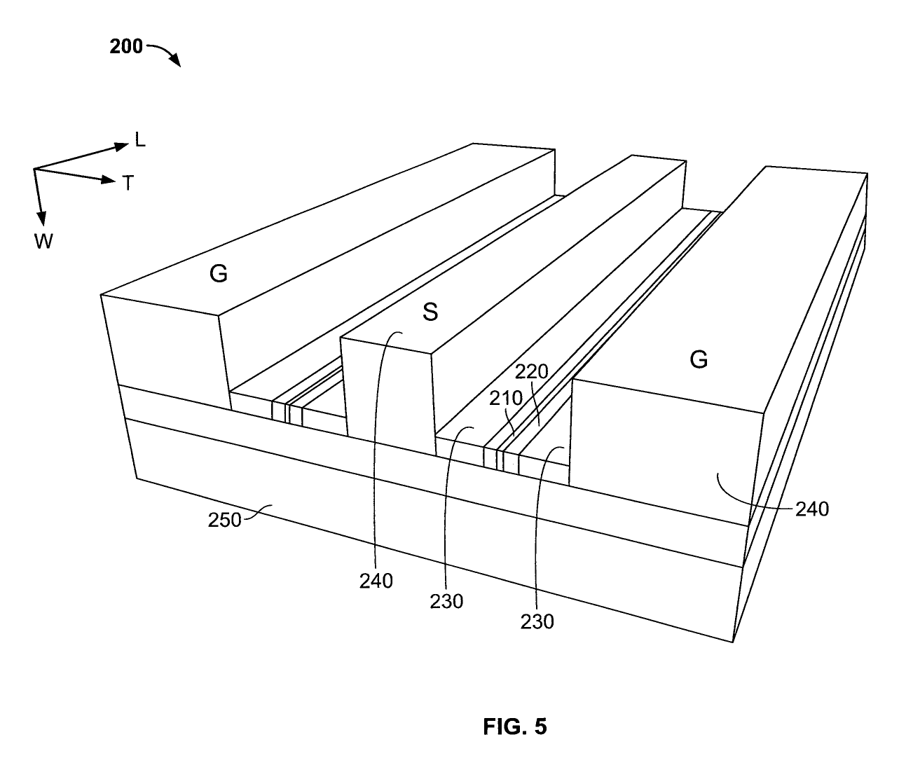

FIGS. 4 and 5 illustrate another exemplary EO modulator 200 in accordance with aspects of the present invention. EO modulator 200 is a vertical dual slot waveguide modulator. EO modulator 200 is operable to modulate a radio-frequency (RF) signal onto a beam of light. In general, EO modulator 200 includes an EO polymer layer 210, semiconductor layers 220, ferroelectric material layers 230, and electrodes 240. Additional details of EO modulator 200 are described below.

EO polymer layer 210 provides slots for confining optical and RF modes in EO modulator 200. As shown in FIG. 4, EO polymer layer 219 has a first surface 212 and a second surface 214 opposite the first surface. EO polymer layer 210 has a relatively low refractive index in both the optical and RF domains. EO polymer layer 210 is substantially the same as EO polymer layer 110 described above.

Semiconductor layers 220 are positioned on each side of EO polymer layer 210. As shown in FIG. 4, one semiconductor layer 220 is positioned on surface 212 of EO polymer layer 210, and another semiconductor layer 220 is positioned on surface 214 of EO polymer layer 210. Each semiconductor layer 220 has a surface 222 opposite the EO polymer layer 210. Semiconductor layers 220 have a higher refractive index in the optical domain than EO polymer layer 210. Semiconductor layers 220 are substantially the same as semiconductor layers 120 described above.

Ferroelectric material layers 230 are positioned on the side of each semiconductor layer 220 opposite EO polymer layer 210. As shown in FIG. 4, one ferroelectric material layer 230 is positioned on surface 222 of one semiconductor layer 220, and another ferroelectric material layer 230 is positioned on surface 222 of another semiconductor layer 220. Each ferroelectric material layer 230 has a surface 232 opposite the respective semiconductor layer 220. Ferroelectric material layers 230 have a lower refractive index in the optical domain than semiconductor layers 220, and a higher refractive index in the RF domain than semiconductor layers 220. Ferroelectric material layers 230 are substantially the same as ferroelectric material layers 130 described above. Ferroelectric material layers 230 may desirably be thicker than the combined thickness of EO polymer layer 210 and semiconductor layers 220.

As shown in FIG. 4, a portion 216 of EO polymer layer 210 may extend beyond the edges of semiconductor layers 220. This portion 216 of EO polymer layer 210 may have a thickness greater than the portion of EO polymer layer 110 between semiconductor layers 220.

Electrodes 240 are positioned on the side of each ferroelectric material layer 230 opposite respective semiconductor layers 220. Electrodes 240 are coupled to apply an electric field across EO polymer layer 210, semiconductor layers 220, and ferroelectric material layers 230. Electrodes 240 are substantially the same as electrodes 140 described above.

As shown in FIG. 5, for example, each layer of EO modulator 200 has a length much greater than its width. EO modulator 200 may be approximately 1-2 cm long (the length direction indicated by arrow L in FIG. 5) and approximately 1-2 μm wide (the width direction indicated by arrow W in FIG. 5). The length of EO modulator 200 may desirably be selected based on the wavelengths to be confined within EO polymer layer 210. The thicknesses of each layer of EO modulator 200 may be substantially the same as the thicknesses described above for the respective layers of EO modulator 100.

EO modulator 200 is desirably mounted to a substrate 250. Substrate 250 may be a conventional complementary metal-oxide-semiconductor (CMOS) substrate. In a particular embodiment, substrate 250 is a silicon substrate made of a silicon-on-insulator (SOI) wafer. As shown in FIG. 4, the thickness direction of the EO polymer layer 210 (indicated by arrow T in FIG. 5) is substantially parallel to the plane of substrate 250 (i.e., EO modulator 200 is has vertically-oriented slots for confining the optical and RF modes). As shown in FIG. 4, multiple EO modulators may be arrayed in parallel on the same substrate 250. In an exemplary embodiment, two EO modulators 200 are embedded in the gaps of a coplanar waveguide (which comprises one signal and two ground electrodes 240). In such a configuration, multiple EO modulators 200 may share a single central electrode 240, as shown in FIGS. 4 and 5, in which the electrical field is aligned in the opposite direction. Thereby, a single electrode 240 may provide the signal to multiple EO modulators 200. Where multiple EO modulators 200 are used, two modulators may be used together as a push-pull EO modulator configuration to form an intensity modulator, as would be understood to one of ordinary skill in the art from the description herein.

EO modulator 200 may be fabricated through conventional lithography methods. For example, SOI wafer may be etched in the semiconductor material to form a slot waveguide. With a mask on the top of the slot waveguide, a ferroelectric material may then be deposited on the wafer. After liftoff, two ferroelectric material layers 230 can be defined. At last, electrodes 240 may be deposited on substrate 250 by conventional vapor deposition techniques, and then an EO polymer may be deposited in the gap to form EO polymer layer 210. Suitable fabrication methods for EO modulator 200 will be understood by one of ordinary skill in the art from the description herein.

The operation of EO modulator 200 is substantially the same as the operation of EO modulator 100. Electrode 240 applies the signal (in the form of an electric field) across EO polymer layer 210, semiconductor layers 220, and ferroelectric material layers 230 in the thickness direction. The optical portion of the signal is confined within EO polymer layer 210 between semiconductor layers 220 (as shown by diagram 260 in FIG. 4). Diagram 260 shows an exemplary confinement profile of the optical mode within EO polymer layer 210. EO modulator 200 may achieve an optical confinement factor Γ in the EO polymer layer 210 of at least approximately 36.5%. Additionally, during operation, EO modulator 200 will confine an RF portion of the signal within EO polymer layer 210 (as shown by diagram 270 in FIG. 4). Diagram 270 shows an exemplary confinement profile of the RF mode within EO polymer layer 210. In an exemplary embodiment, when a voltage of 1 volt is applied between signal and ground electrodes 240, EO modulator 200 may achieve an RF confinement of over one million V/m. Confinement of both optical and RF modes in EO polymer layer 210 may desirably enable high bandwidth operation of EO modulator 200.

As set forth above, the above-described electric field confinement with EO polymer layer 210 induces a significant change in the refractive index of EO polymer layer 210. Additionally, ferroelectric material layers 230 allow for a relatively large separation between electrodes 240 without significantly decreasing the electric field confinement in EO polymer layer 210. As a result, the RF mode may experience reduced conduction loss.

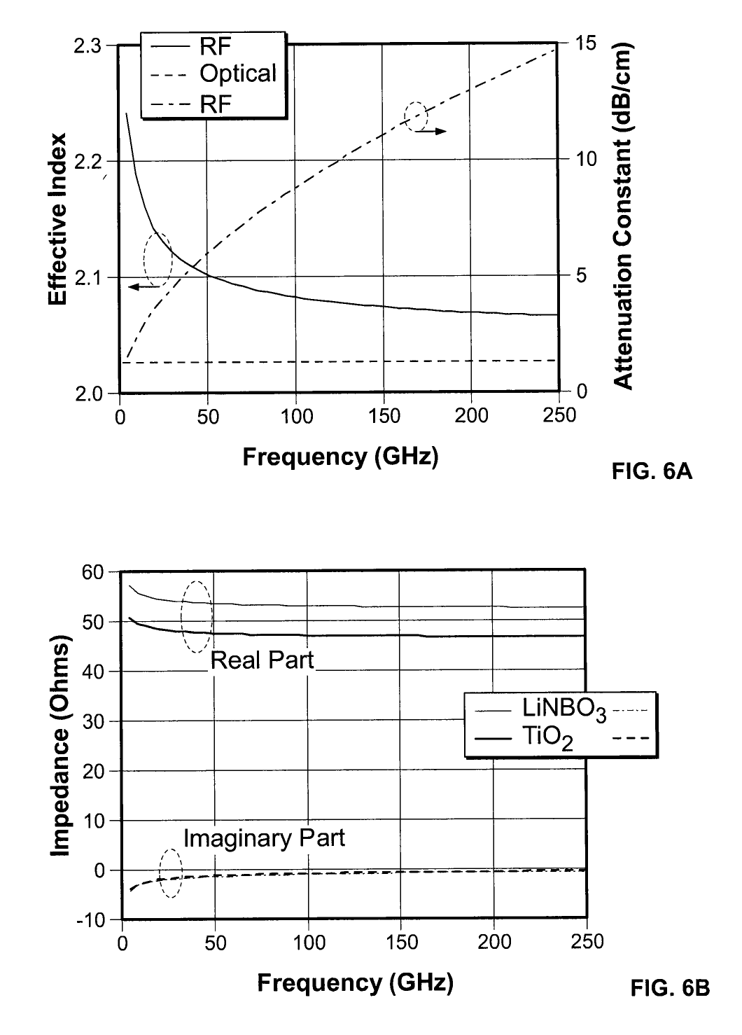

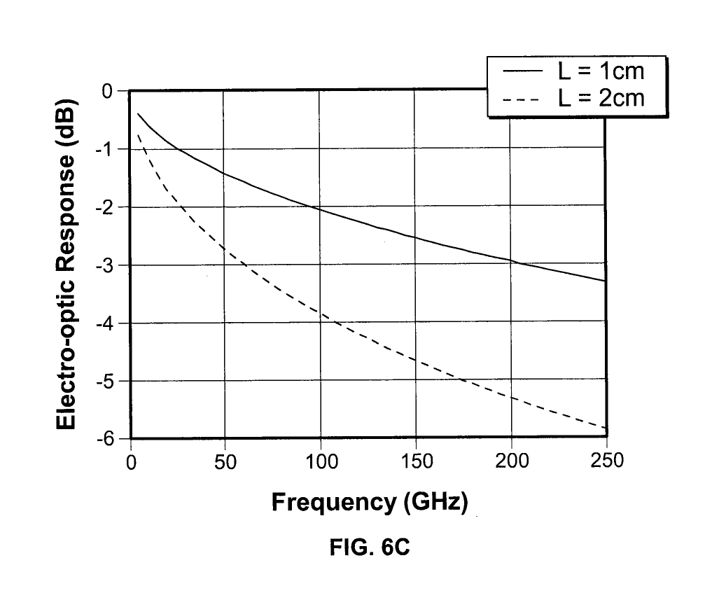

This may be particularly important for operation of EO modulator 200 at high frequencies. FIGS. 6A-6C are graphs of the broadband frequency response of EO modulator 200 for optical and RF effective indices and RF loss (FIG. 6A), RF impedance (FIG. 6B) and electro-optic response (FIG. 6C). These graphs show that EO modulator 200 is capable of operating at high frequencies up to 300 GHz.

The above described EO modulators may achieve the following advantages over prior art modulators.

Aspects of the present invention provide CMOS compatible, broadband, high speed traveling wave EO modulators. The disclosed modulators achieve advantages over conventional EO modulators, for example, by incorporating advanced organic EO polymer materials into novel dual optical and RF nano-slot waveguides. The strong optical and RF mode concentration, and mode overlapping within the nano-slot enables a significant enhancement of EO modulation and sensitivity, which may be two orders of magnitude better than that of conventional traveling wave EO modulators. The novel RF transmission line design significantly reduces the RF loss and thereby enables the proposed devices to operate over a very large bandwidth, i.e., up to 300 GHz, which covers entire RF frequency band.

The proposed horizontal and vertical dual slot waveguide EO modulators have advantages over conventional traveling wave modulators from a variety of aspects. These advantages include: 1) stronger RF electric field confinement within a nanometer-sized slot; 2) stronger optical and RF mode overlap; 3) lower optical and RF loss due to a large electrode gap; 4) CMOS (silicon based) compatibility; 4) implementation of an EO polymer having a high EO coefficient, and 5) ease of EO polymer material preparation, i.e., polling process. As a result, the driven half-wave voltage of the modulator, VπL, may be decreased by nearly two orders of magnitude in comparison to that of conventional EO modulators.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An electro-optic modulator comprising:
an electro-optic polymer layer having a first surface and a second surface opposite the first surface, the electro-optic polymer layer having a refractive index in the optical domain and a refractive index in the RF domain;
a semiconductor layer positioned on each of the first and second surfaces of the electro-optic polymer layer, each semiconductor layer having a refractive index in the optical domain and a refractive index in the RF domain, the refractive index of the semiconductor layers in the optical domain higher than the refractive index of the electro-optic polymer layer in the optical domain, the refractive index of the semiconductor layers in the RF domain higher than the refractive index of the electro-optic polymer layer in the RF domain;
a ferroelectric material layer positioned on a surface of each semiconductor layer opposite the electro-optic polymer layer, each ferroelectric material layer having a refractive index in the optical domain and a refractive index in the RF domain, the refractive index of the ferroelectric material layers in the RF domain higher than refractive indices of both the electro-optic polymer layer and the semiconductor layers in the RF domain, the refractive index of the ferroelectric material layers in the optical domain lower than the refractive index of the semiconductor layers in the optical domain; and
an electrode positioned on a surface of each ferroelectric material layer opposite the semiconductor layer.

2. The modulator of claim 1, wherein the electro-optic polymer layer comprises a layer of an organic chromophore.

3. The modulator of claim 2, wherein the electro-optic polymer layer comprises at least one of PMMA-DR1, SEO-100, SEO-200.

4. The modulator of claim 1, wherein the semiconductor layer comprises silicon.

5. The modulator of claim 1, wherein the ferroelectric material layer comprises at least one of LiNBO₃ and TIO₂.

6. The modulator of claim 1, wherein a thickness of each of the ferroelectric material layers is greater than a combined thickness of the electro-optic polymer layer and the semiconductor layers.

7. The modulator of claim 1, wherein the electrodes comprise a signal electrode formed on the surface of one ferroelectric material layer opposite the semiconductor layer and a ground electrode formed on the surface of the other ferroelectric material layer opposite the semiconductor layer.

8. The modulator of claim 1, wherein:
a portion of the electro-optic polymer layer extends in a width direction beyond an edge of each of the semiconductor layers.

9. The modulator of claim 1, wherein the modulator is mounted to a substrate.

10. The modulator of claim 9, wherein the substrate is a CMOS substrate.

11. The modulator of claim 10, wherein a thickness direction of the electro-optic polymer layer is substantially orthogonal to a plane of the substrate.

12. The modulator of claim 10, wherein a thickness direction of the electro-optic polymer layer is substantially parallel to a plane of the substrate.

13. The modulator of claim 12, wherein:
the electrodes comprise portions of a coplanar waveguide; and
the EO polymer layer, the semiconductor layers, and the ferroelectric material layers are positioned within a gap of the coplanar waveguide.
